(19) United States
(12) Patent Application Publication
(10) Pub. No.: US 2015/0061474 A1
(43) Pub. Date: Mar. 5, 2015

(54) Product Vending Enclosure

(71) Applicant: Fastcorp 2, LLC, Shawnee Mission, KS (US)

(72) Inventors: Fernando A. Ubidia, Ludlow, MA (US); Aaron Stein, Middletown, CT (US)

(21) Appl. No.: 14/012,616

(22) Filed: Aug. 28, 2013

(51) Int. Cl. G07F 9/10

(52) U.S. Cl. CPC G07F 9/10
USPC 312/35; 29/525.14; 29/428

(57) ABSTRACT

The present invention generally pertains to an enclosure constructed from homopolymer and/or copolymer thermal plastic, preferably polypropylene members and a method of construction therefore. Particularly, such enclosures are utilized in the construction of vending machines, product dispensing machines and the like. The polypropylene members used for the enclosure material are at least partially formed from homopolymer polypropylene, or copolymer polypropylene, or a combination of homopolymer and copolymer polypropylene.

### CROSS-REFERENCE TO RELATED APPLICATION

This application claims priority to U.S. Provisional Application Ser. No. 61/694,996 filed Aug. 30, 2012, the entirety of which is incorporated herein by this reference.

### FIELD OF THE INVENTION

The present invention relates generally to an exterior enclosure of a product vending machine as well as a method of construction of such exterior enclosures. The enclosure is constructed of homopolymer and/or copolymer, preferably a thermal plastic such as polypropylene, material. Generally, the construction of the enclosures is achieved by either welding or bending, or both, one or more sheets of the homopolymer and/or copolymer polypropylene material into a desired shape of a product vending machine. Various additionally homopolymer and/or copolymer polypropylene segments may be welded to the overall cabinet structure to create shelves and or supports for various internal vending machine components such as refrigeration units, a user interface, product holding devices or electromechanical components and the like. The various product vending components may also be secured directly to the polypropylene enclosure, shelves and/or support segments.

### BACKGROUND OF THE INVENTION

Typical vending machine enclosures for vending and dispensing equipment are constructed using sheet metal to form the enclosures. The sheet metal is mechanically fastened together and/or welded using traditional metal welding techniques. Such metal enclosures provided the structure necessary for maintaining products in a controlled environment, and prevent theft of products. In order to produce the sheet metal members economically, large and costly capital equipment is required such as turret presses, shears, and press breaks.

Traditional metal materials used for enclosures, usually steel and sometimes aluminum, are very strong. However, they are also relatively heavy materials, and therefore the material thickness of the enclosure members is limited for practical use concerning enclosure weight (as well as material cost). It is not uncommon for vending machine enclosures to be six feet in height and several feet wide and deep. For enclosures of this size, the thickness of the sheet metal members is necessarily made thin, and despite the material strength of metals, the thin material sections are structurally weak. This is often times mitigated by welding or fastening additional metal members to add strength. However, this adds to the overall cost of the enclosure.

In construction, multiple thin enclosure members are welded and/or fastened together to achieve the strength required for the enclosure. The process of metal welding requires the welder to undergo extensive training and posses a very high skill level to properly execute the technique. The mechanical fastening process requires additional parts such as screws, rivets, etc. which add to the cost of the enclosure and typically do not create as strong a joint as welding. Also, utilizing metal as the primary structural component adds significant weight to the overall vending machine. Metal enclosures further require additional painting or plastic covers in order to make them aesthetically attractive to customers as well as to prevent oxidation and corrosion.

For practical applications, sheet metal enclosures are restricted in their shape to square or angular geometry. This is due to a number of factors: the equipment and processes for creating complex geometry or surface contours on large sheet metal members is often cost prohibitive; the process for joining complexly contoured sheet metal shapes is difficult; and the minimal thickness of the sheet metal members does not allow for any substantial edge finishing or embellishment (bevels, radii, high relief engraved designs etc.). The manufacturing process for production volumes of sheet metal enclosures requires several sets of permanent tooling to produce the geometric features of the enclosure, features such as holes, slots, bends etc., in a cost effective manner. Therefore, design changes for sheet metal enclosures are costly, requiring modification to the permanent tooling, or the creation of new tools altogether.

### SUMMARY OF THE INVENTION

The present invention solves the foregoing problems through the utilization of a unique structural material as well as a unique method of manufacture in the production of product vending machines. The present invention generally pertains to an enclosure constructed from homopolymer and/or copolymer, preferably a thermal plastic such as polypropylene, members and a method of construction therefore. Particularly, some embodiments of such enclosures are utilized in the construction of vending machines, product dispensing machines and the like. In certain embodiments, the polypropylene members used for the enclosure material are comprised entirely of homopolymer polypropylene, or entirely of copolymer polypropylene, or a combination of homopolymer and copolymer polypropylene members may be used.

Embodiments of the present invention provide for the polypropylene members utilized in the manufacture of the enclosure to be joined by hot gas (typically air or nitrogen) welding or extrusion welding. In the joining process, the plastic members are, in some embodiments, welded together to form a unitary, structure without the utilization of fasteners or brackets. The construction of the enclosure also reduces the appearance of welding beads which are typically found when two or more sections of metal are joined together, as the welding joints created in the construction of the vending machine cabinets are capable of being substantially ground down and smoothed to reduce their profile.

Alternately, in some embodiments, heat bending of a single flat polypropylene sheet is utilized to create the multiple facets of an enclosure. In creating an enclosure utilizing a single sheet of material, it is preferable that a groove is cut into the material at the bending location. The groove facilitates the bending of the material at the proper location and allows for a tight bend radius by minimizing the material displaced at the inside joint of the bend. Heated bending also eliminates the need for additional welding as the heated material on the inside of the bend fuses together upon completion of the heated bending process.

The utilization of polypropylene sheets in forming the enclosure structure also allows the structure to be formed into curves and other contoured shapes so that in some embodiments, complex geometry are capable of being added to the enclosure. The polypropylene enclosures naturally have strong resistance to weathering and chemicals, and they require no paint or coatings to protect their surface. Furthermore, embodiments provide for additional polypropylene members to be welded to the enclosure walls to create I-sections, T-sections, and/or U-sections to increase the structural strength and rigidity of the enclosure in high load bearing areas. Additional shelving and support elements are also be included in other embodiments. Thus while the overall structure of the cabinet is capable of being reinforced with a variety of other materials, it need not be. Embodiments provide for the overall structural integrity of the enclosure to be reliant on the polypropylene material.

Utilizing polypropylene material as a structural enclosure also provides for construction techniques and parameters that are simpler and more economical than those of traditional sheet metal enclosures. The quantity and cost of the equipment required to manufacture the polypropylene enclosures, such as CNC routers and bending bars are less that that required in the construction of metal enclosures as well. And while hot gas, or extrusion welding, and heated bending require training to properly execute, the welding and bend operations do not require that workers have the high a degree of skill necessary for welding metal. Consequently, labor costs for the production the polypropylene enclosure are reduced.

Many of the polypropylene enclosure walls are capable of being formed using heated bending of a single sheet, which reduces the number of separate parts needed for the enclosure. Eliminating the need for fasteners reduces the overall number of parts required for the enclosure. Additionally, polypropylene sheets are capable of being cut much easier and without specialized equipment than metals, which further reduces the manufacturing cost of the enclosure members.

Polypropylene is very light in comparison to metals—it has approximately 1/10th the density of steel and approximately ⅓rd the density of aluminum. Enclosures of polypropylene are capable of being produced in much greater material thickness than sheet metal and yet still have comparable weight as that of a sheet metal enclosure of the same size. The mechanical strength of the polypropylene enclosure is equivalent to and often greater than that of a sheet metal enclosure. Furthermore, polypropylene is much more impact resistant, and a polypropylene enclosure is capable of withstanding impacts that would permanently damage a sheet metal enclosure.

For example, impact to the wall of a sheet metal enclosure, possibly from being tipped over, kicked or hit, will result in denting and marring the enclosure. In such instances, it is impractical to repair the damage to the metal due to the relative difficulty of working with sheet metal. Particularly, a repair will generally require cutting, welding and grinding of the sheet metal, followed by painting to repair a damaged metal enclosure. However, due to the ease of working with polypropylene, embodiments of the present invention provide for a similarly damaged polypropylene enclosure to readily be repaired. The damaged section of the enclosure is capable of being cut away and a new section of polypropylene material is shaped and welded in place.

The polypropylene enclosure is particularly suitable to complex surface contours. The polypropylene members are capable of being formed into complex shapes using heat forming, and the shaped members are capable of being easily be welded to the enclosure structure using the plastic welding methods of the present invention. Since the polypropylene members are capable of being practically manufactured with a substantial thickness, and because it is efficiently machined, embodiments of the present invention provide for bevels and radii and other, more complex edge finishes to be added to the enclosure, and complex geometry to be cut into the enclosure walls themselves. This gives the polypropylene enclosure a greater number of both functional and aesthetic design options while maintaining a cost effective design. The manufacturing process for the polypropylene enclosure members also requires little to no permanent tooling. The members are capable of being efficiently manufactured on CNC cutting equipment, and if design changes are needed, a programming change—rather than a tooling change—is all that is required.

Another advantage that the thick walls of the polypropylene enclosure provides is the capability to effectively mount the internals of the vending and dispensing equipment (robotics, electronics, currency handling devices, etc.) directly to the walls by using self threading fasteners. Due to the thin material thickness of sheet metal members, sheet metal screws must be used, which are prone to stripping, or threaded inserts—which add cost to the equipment—are required to adequately fasten the internal devices. The polypropylene enclosure does not require threaded inserts, and provides a cost effective means to securely mount the internal devices.

### DRAWINGS

FIG. 1 is an exploded view of a product vending enclosure.

FIG. 2 is a perspective view of one embodiment of the product vending enclosure including various internal components.

FIG. 3 is an exploded view of a product vending enclosure manufactured utilizing a combination of heated bending and welding.

FIG. 4 is a perspective view of a product vending enclosure that may be manufactured utilizing a combination of heated bending and welding.

FIG. 5A is a plan view of two pieces of material welded together.

FIG. 5B is a cross sectional view as taken along the line A-A of FIG. 5A.

FIG. 6A is a plan view of two perpendicular pieces of material welded together.

FIG. 6B is a cross section view as taken along the line B-B of FIG. 6A.

FIG. 7A is a plan view of a piece of material that has been heated and bent to form a perpendicular corner welded at the bending site.

FIG. 7B is a cross sectional view as taken along the line C-C of FIG. 7A.

FIG. 8 is a depiction of an example of a screw fastener engaged in a section of material.

FIG. 9 is a depiction of another example of a screw fastener engaged in a section of material.

FIG. 10 is a perspective view of an embodiment of an enclosure including a door secured by a securing mechanism.

FIG. 11 is a perspective view of another embodiment of an enclosure including a door secured by a securing mechanism.

FIG. 12 is a perspective view of an embodiment of an enclosure having a door that pivots about an axis.

FIG. 13 is an exploded view of an embodiment of a door.

FIG. 14 is a perspective view of a door.

FIG. 15 is a perspective view of an embodiment of a product vending enclosure

FIG. 16A is a perspective view of a panel of material having grooves along bending sites.

FIG. 16B is a perspective view of a panel that has been bent along grooved bending sites to form a “U” shape.

FIG. 17 is a perspective view of an embodiment of a vending enclosure including various shelves and structural supports.

### DETAILED DESCRIPTION OF THE PREFERRED EMBODIMENT

Throughout the specification, wherever practicable, like structures will be identified by like reference numbers.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated or except as will be readily apparent to those skilled in the art from the description. For example, a feature, structure, act, etc. described in one embodiment may also be included in other embodiments, but is not necessarily included. Thus, the present technology can include a variety of combinations or integrations of the embodiments described herein.

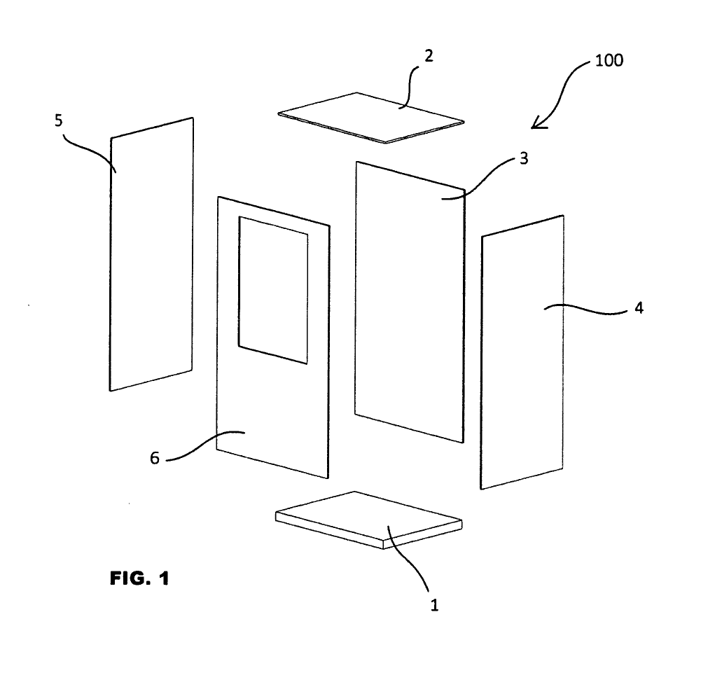

Preferably in embodiments of the present invention, polypropylene material is utilized to create an enclosure of a vending machine. It is also preferable that a homopolymer is utilized to create the exterior of the vending machine as its utilization results in a more aesthetically pleasing surface finish, withstands higher temperatures and is more rigid than a copolymer. A first method of constructing the enclosure begins with multiple sheets of polypropylene material. In some embodiments, the sheets are precast into particular desired shapes, or in alternative embodiments, are cut from a larger sheet into desired shapes. In the most basic embodiments of an enclosure, such as a typical rectangular box design shown in an exploded view in FIG. 1, enclosure 100 begins with six sheets or panels of material, a bottom 1, a top 2, a back 3, two sides 4, 5 and a front 6 where, in some embodiments, the front 6 comprises a door.

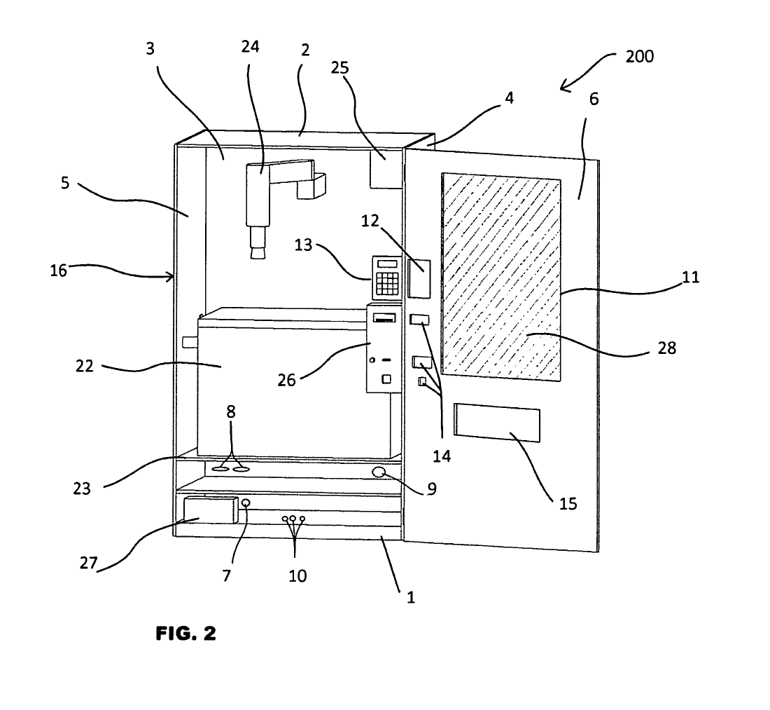

FIG. 2 is an example of an embodiment of a front opening vending machine enclosure. Creating a font-opening vending machine begins by forming necessary openings in the various sheets. For example, in certain embodiments, the back 3 includes a hole 7 cut for a power cord or venting holes 8 and a hole 9 for a fluid pipe. Similarly, the bottom 1 includes holes 10 for venting or drainage. In some embodiments, the front sheet 6 includes a viewing window 11, a hole 12 for a user interface 13, slots 14 for monetary transactions, and a product dispensing hole 15. Embodiments of the present invention provide for the various holes to be cut and/or shaped using a router in order to impart a smooth or decorative finish. Other embodiments provide for the various sheets to also be engraved with various designs 53 (see FIG. 11), for example, a design signifying the product to be sold. Preferably, the various holes, slots, openings and designs are cut using a CNC router. Such routers are easily programmable and therefore creating the desired cuts only requires entering a particular program into the router. Also, in some embodiments, particular ones of the sheets of material are bent or shaped. For example, certain embodiments provide for the front panel to be rounded or curved to provide an added geometric element to the vending machine.

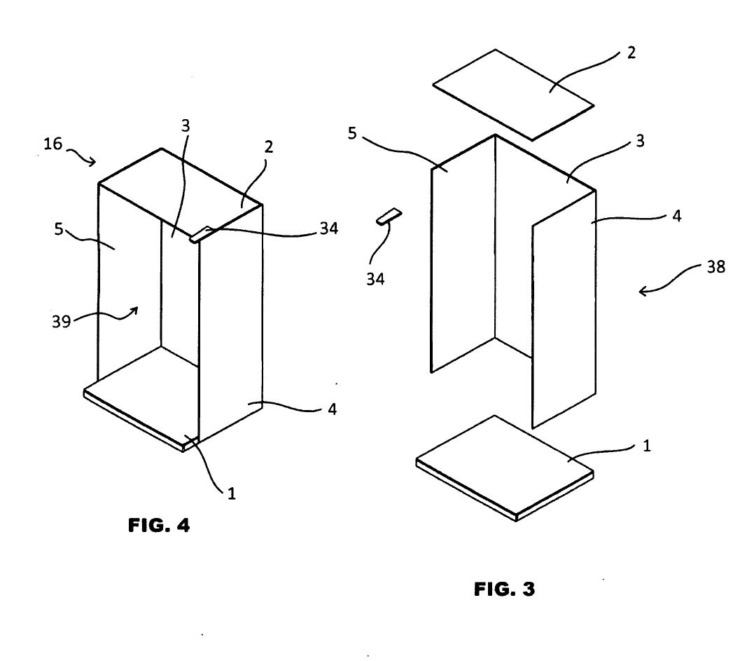

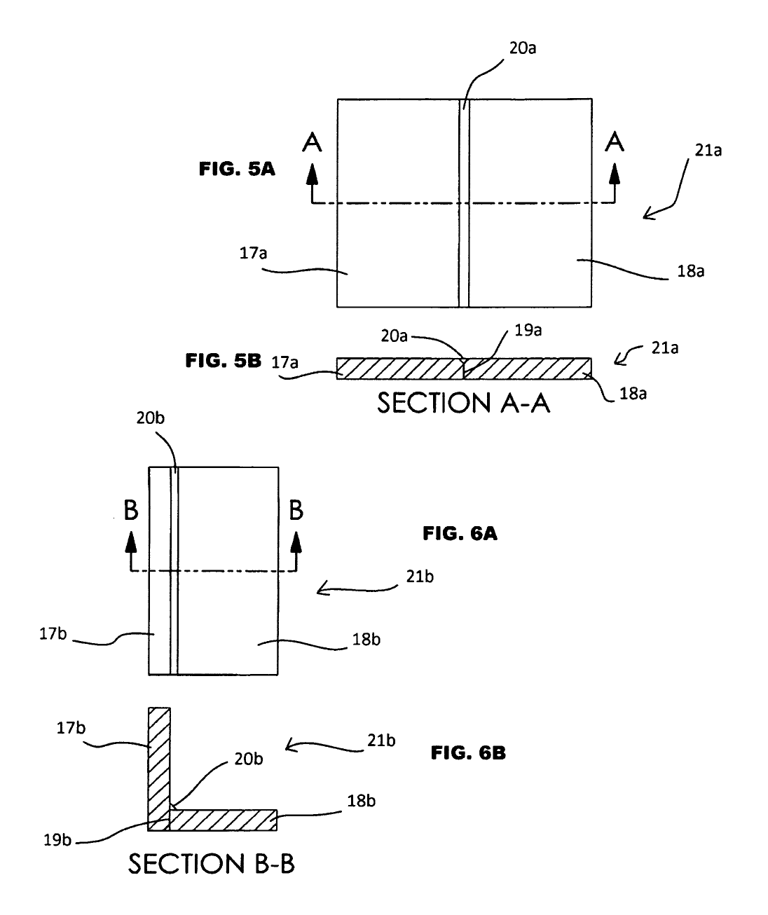

With reference to FIGS. 3 and 4, upon forming the proper features, such as holes, engraved designs such as geometric designs to the various panels (not shown), embodiments of the present invention provide for each of the panels to be welded together. Preferably, the back 3, two sides 4, 5, bottom 1 and top 2 are first welded together to form to form an open box 16. In some embodiments, welding the panels is generally accomplished by hot gas and/or extrusion welding. As such, two panels are joined by heating and melting a quantity, such a rod having a length approximately equal to that of the desired weld, of material of the same like and kind as the panels to be welded, using a heat gun. The quantity of melted material is applied to the desired weld joint and allowed to cool thereby joining the two panels. As shown in FIGS. 5A-5B, two panels of material 17a, 18a are abutted together at joint 19a. A rod of material 20a is laid along the joint 19a between panels 17a and 18a to join the panels together and form a single larger panel 21a. Alternately, in other embodiments, a corner is capable of being formed. In FIGS. 6A-6B, two panels of material 17b, 18b are abutted together at joint 19b. A rod of material 20b is laid along the interior of joint 19b to join panels 17b and 18b together to form a corner 21b. In certain embodiments, the weld joints are then smoothed and polished. Embodiments provide for the process to be repeated so as to form the desired shape, such as an open box, of the vending machine.

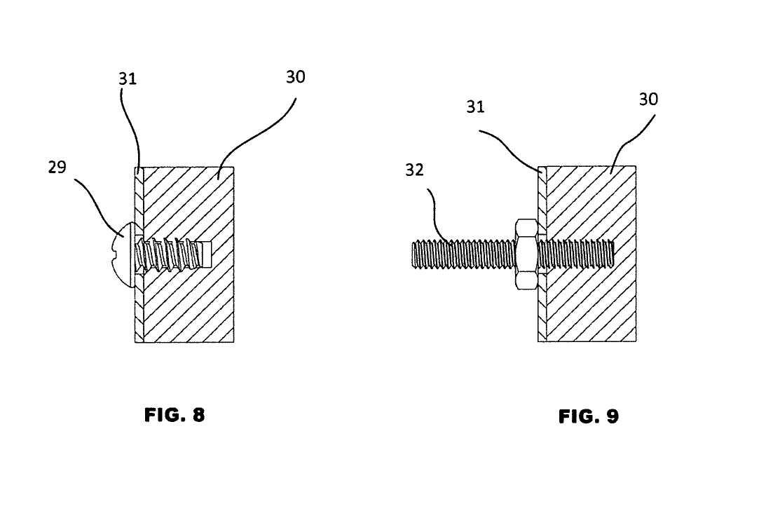

FIG. 2 depicts one configuration of an interior for the product vending enclosure. Upon completing the open box 16, components of the vending machine are connected to the open box. For example, embodiments provide for a product dispensing machine to include a refrigerant portion 22, product support structures such as a shelf or rack 23, electro mechanical mechanisms 24 to release a product, a controller 25 for controlling the electro mechanical mechanisms, a transaction segment 26, a user interface 13, and a power supply 27 secured within the open box. It should be understood that the power supply need not create power, but instead simply transfer power from an external source, such as from a wall socket, to the interior powered components of the product vending machine. In some embodiments, a sheet of clear material 28, such as a transparent glass or Plexiglas is secured to the front panel 6 to crate a viewing window 11. Preferably, self tapping screws are used to secure the various components to the panels. The polypropylene material is preferably of a relatively thick gauge. Preferably the material is in the range of 0.25 to 0.50 inches thick where primary load bearing members, such as the base, utilize material having a thickness of 0.375 inches and secondary load bearing members, such as the sides and back utilize material having a thickness of 0.25 inches. The thick gauge also allows for screws to be bored directly into the material. Thus, as shown in FIGS. 8 and 9, screws 29, 32 are provided with sufficient bite to engage the polypropylene panel 30 and securely fasten various components, such as component 31. Such construction allows the vending machine components to be securely fastened within the enclosure without the use of additional fastening braces.

While embodiments of the present invention provide for other fasteners than screws to be used, the preferred screw fasteners provide some additional benefits. As shown in FIGS. 8 and 9, due to the relatively thick gauge, the screws, 29, 32 are secured without fully penetrating the panel 30. That allows the vending components to be adequately secured within the enclosure without marring the external sides of the panels. Without any external damage, as is generally caused by using bolts and rivets that fully penetrate traditional sheet metal enclosures, there is no additional cover up work to be done in order to make the exterior of the enclosure aesthetically pleasing. It also prevents any engraved design present on the exterior of the panels from being damaged.

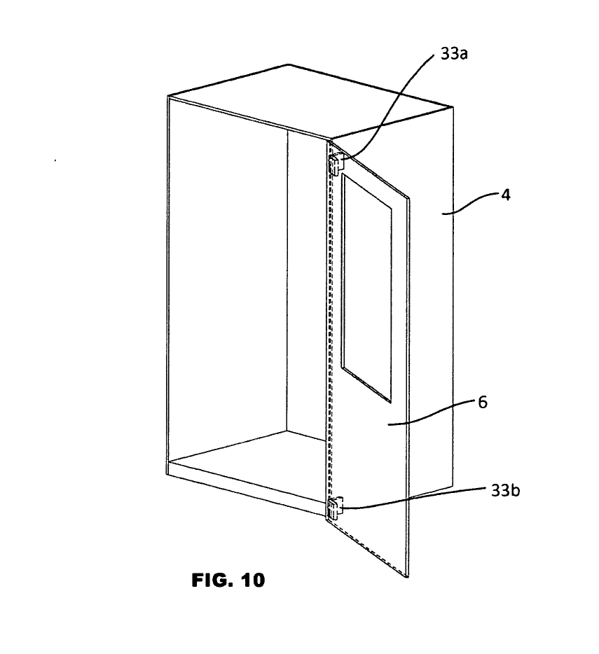

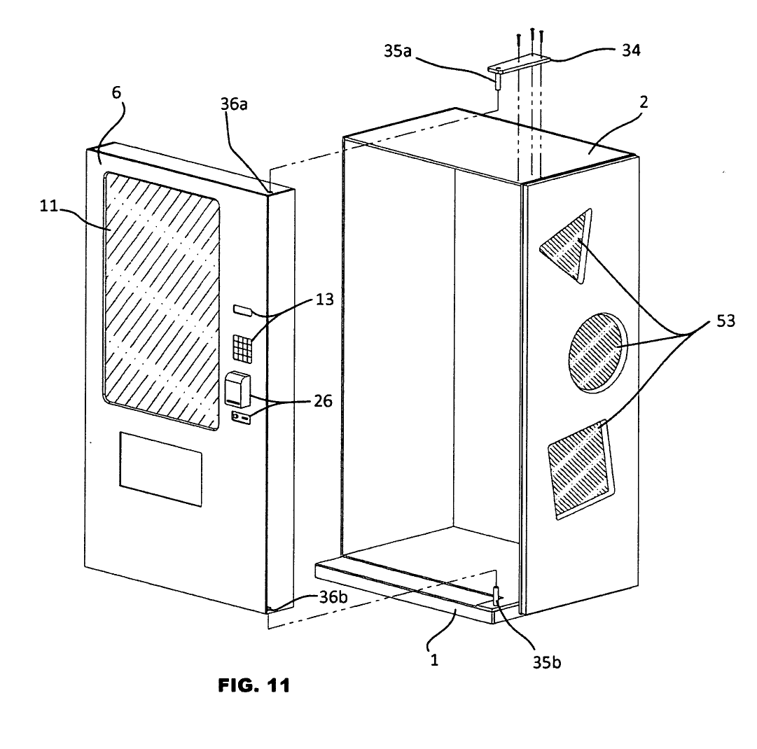

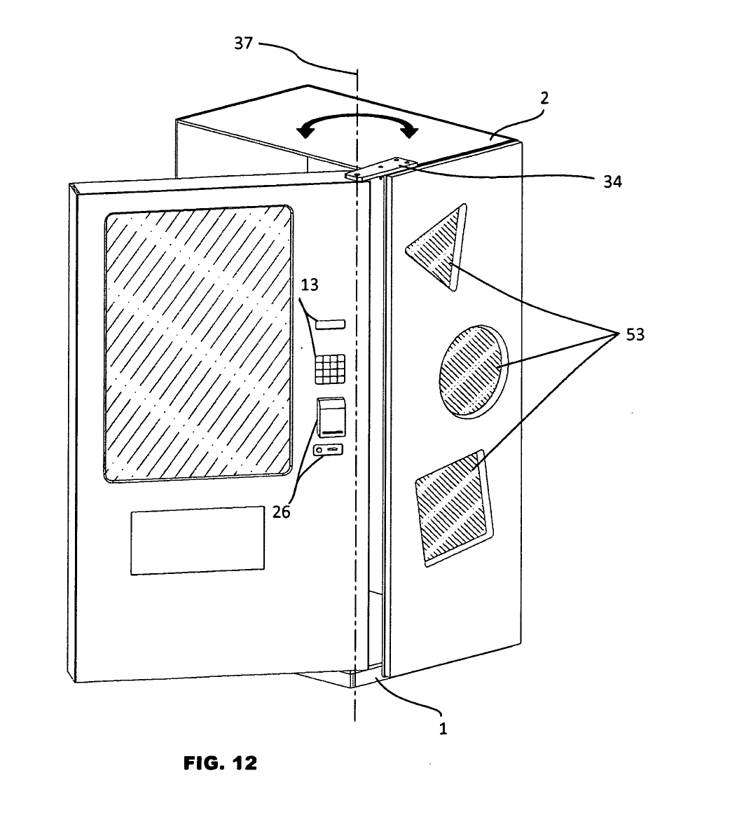

In certain embodiments, upon securing the various vending machine components to the interior of the open box, the front panel 6, such as a front door, is added to finish the enclosure 200 as shown in, for example FIG. 2. In some embodiments, the addition of the front panel is accomplished by affixing one or more securing mechanisms, such as hinges, to the open box and to the front panel. For example, as shown in FIG. 10, where the front panel 6 is depicted as transparent for the proposes of explanation, traditional door hinges 33a, 33b are screwed into a side panel 4 and are also be screwed into the front panel 6 so as to permit the front panel to open and close. Alternately, FIGS. 11-12 depict another embodiment where one hinge having a fastening plate 34 and rod or pin 35a are affixed to the top panel 2 and another rod or pin 35b are affixed to the bottom panel 1. In some embodiments, the rod or pin elements are inserted into a top hole 36a and a bottom hole 36b in the front panel 6 so as to allow the font panel to swivel on an axis 37 created by the rods or pins of the hinge. Embodiments provide for various other types of hinges to be used. While hinges are preferred, in other embodiments, other well-known securing mechanisms, such as clips, clasps, locks and the like are utilized. Securing the front panel to the open box completes the enclosure.

In the event that a part of the enclosure is damaged, either during construction or once the enclosure is placed in the field, embodiments of the present invention provide for the damaged enclosure to be easily repaired. In certain embodiments, to repair a damaged panel, the damaged section is cut away from the overall enclosure. A new, replacement panel (or panels) is cut from sheets of polypropylene material to fit the section that was cut away. In some embodiments, a CNC router is programed to cut or carve the necessary replacement holes, slots, openings or engraving designs into the replacement panel, so as to mimic those design elements removed along with the damaged section. Embodiments then provide for the replacement section to then be welded to the enclosure panels in the proper orientation. Thus, the damaged section is removed, and a replacement section added in a relatively seamless manner, virtually eliminating the evidence of the damaged section. The enclosure is then operable to be placed back into service in the field with little to no aesthetically off-putting signs of damage, without the need to scrap, salvage and rebuild a new enclosure, and without the need to employ highly skilled labor.

Alternately, in some embodiments, a heat bending process, preferably in combination with the hot gas or extrusion welding process, is utilized to construct the enclosure. The heat bending process begins with a sheet of polypropylene material that is formed or cut into a geometric shape that when bent properly, forms an appropriately sized and proportioned elements of the enclosure. Using a traditional rectangular box style enclosure as an example, the process begins with a large rectangular shape.

Similar to the construction utilizing multiple panels, in some embodiments, the single sheet of polypropylene is further cut to provide holes, slots, vents, other openings or engraved designs. Preferably, a CNC router is programed so as to perform the proper cutting/routing in the single sheet of material. Once the necessary holes and designs have been formed, embodiments provide for the material to be bent into the proper shape. In certain embodiments to bend the sheet without damaging or breaking it, heat bars are used to heat the material along a bend line. A heat bar is an elongated bar that is capable of being heated to a temperature sufficient to soften the polypropylene material when the heat bar is placed in close proximity to or placed directly against the polypropylene material. Such heat bars are known devices. Preferably the heat bars are raised to a temperature of between 500 and 600 degrees Fahrenheit depending on the specific homopolymer or copolymer polypropylene material to be bent. The heat bars are applied to the polypropylene material so as to soften it in preparation for bending.

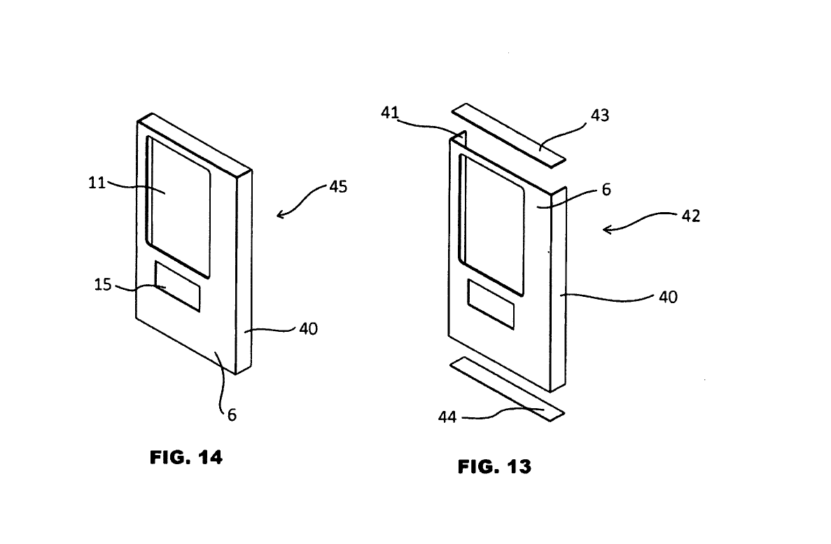

Once softened, preferably to the point where the material has melted, embodiments provide for the polypropylene material to be bent to the desired shape. For example, in certain embodiments heat bars are applied along junction lines that form the joints between the back and sides of the enclosure. The sides are then bent such that they each come perpendicular to the back to form an open “U” shape. The top and bottom are then welded to the open “U” shape to form an open box. The connection points between the sides and back are thus concealed on the inside of the enclosure and the only hot gas or extrusion welds is on the top and bottom of the enclosure. It is preferable that the back and sides of the vending machine are formed by heated bending such that the bending weld is formed on the interior of the cabinet while the top and bottom are welded onto the back and sides utilizing hot gas and/or extrusion welding. Formation of the cabinet according to the forgoing reduces the use of visible welds, regulating the visible welds to the very top and very bottom of the machine where they are unlikely to be observed by a vending machine customer. In some embodiments, the front door is also formed similar to as described above with respect to the open box and then secured to the open box. Such construction is generally depicted in the accompanying FIGS. 13-15.

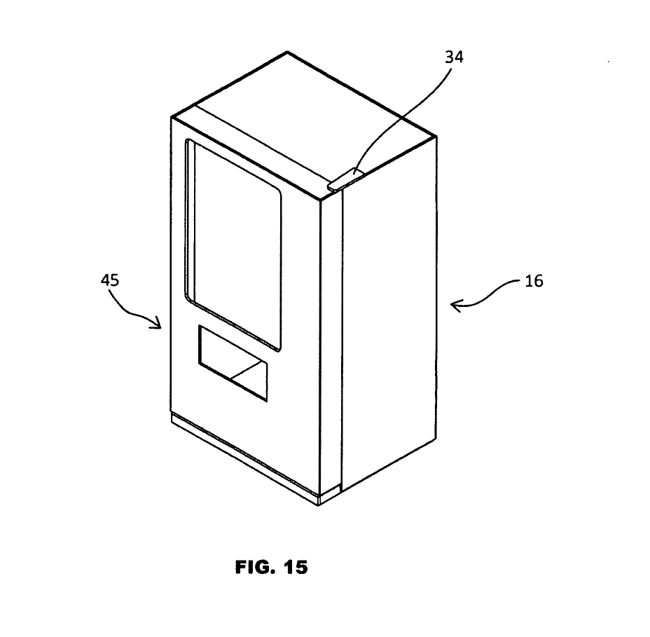

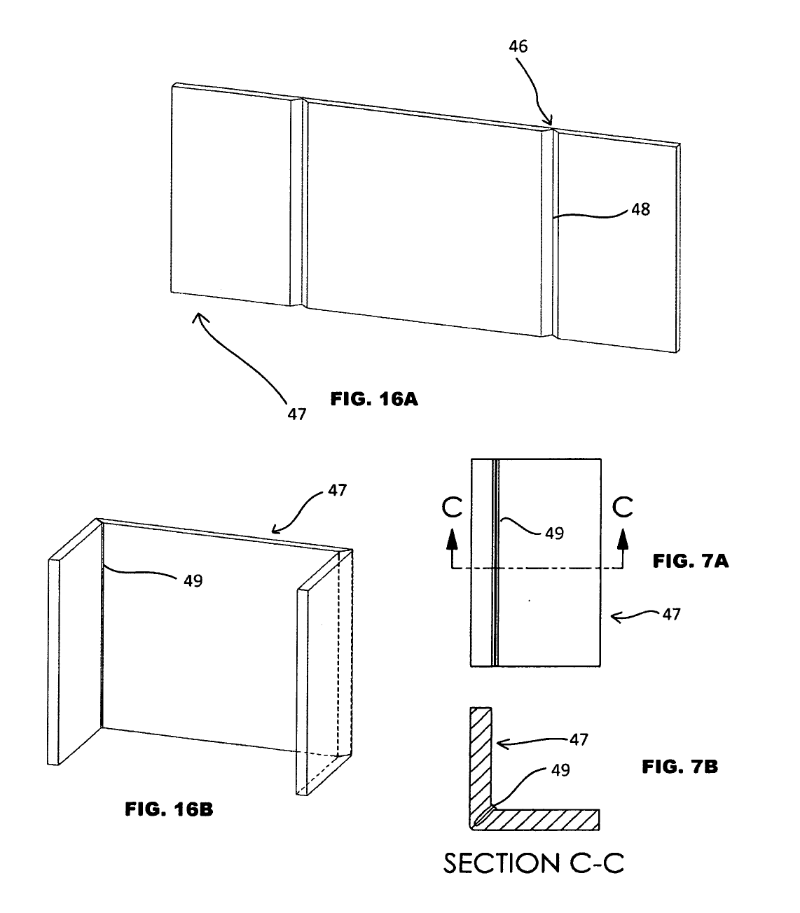

Thus, while one method of forming the enclosure begins with six sheets of material and the various sheets are welded together, embodiments provide for a similar enclosure to be formed using a combination of bending and welding. Referring again to FIGS. 3 and 4 for example, the back 3 and sides 4, 5 form a “U” shaped structure 38, while the top 2 and bottom 1 are flat panels. The top 2 and bottom 1 are welded to the “U” shaped structure 38 forming the open box 16 such that a cavity 39 is formed within the open box 16 and bounded by the back 3, sides 4, 5, top 2 and bottom 1. In some embodiments, additional hinge components, such as top hinge fastening plate 34, are also affixed to the open box 16. In certain embodiments, the above descriptions provided with respect to the enclosure are also capable of being specifically applied to the door that affixed to the open box. Thus, it is understood that the description provided above with respect to forming the enclosure and with respect to various features of the enclosure are likewise and specifically applicable to the door of the present invention. For instance, the door, see FIGS. 13 and 14, is similarly formed where a door front panel 6 with door side walls 40, 41 form a “U” shaped door structure 42. In certain embodiments, the side walls 40, 41 are welded to the front panel 6, such as by the welding process previously described. In certain other embodiments, the “U” shaped door structure 42, including the front panel 6 with door side walls 40, 41, is formed from a single piece of material, using the heat bending process describes above or as described in more detail below. In some embodiments, a door top 43 and a door bottom 44 is welded to the “U” shaped door structure 42 to form the completed door 45, with the door 45 similarly having a cavity bounded by the door front 6, door side walls 40, 41, door top 43 and door bottom 44. As shown in FIG. 14, embodiments provide for the door to include additional features, such as a window 11, that are used for a product viewing window and a hole 15 to provide users with access to a purchased product. Similarly, in certain embodiments, the door 45 will have attached thereto, various features, such as a transaction element 26 and/or user interface 13. In some embodiments, the door 45 will have one or more other openings used for other features, such as for dispensing products. The door 45 is then capable of being connected to the open box 16 by a securing mechanism such as a hinge as shown in FIGS. 11 and 15.

To achieve square or substantially square corners, or otherwise to achieve curves with tight radii, it is preferable in some embodiments of the present invention that a groove is cut into the polypropylene material along the desired bend line. Referring now to FIGS. 7A-7B and 16A-16B, forming the enclosure by bending the various sections of the polypropylene sheet is performed by first machining a V-groove 46 in the polypropylene sheet 47 along the intended bend line 48. A heated bending bar is inserted into the V-groove to heat the polypropylene to a desired softness. The heated bending bar is then removed and the polypropylene sheet is bent along the V-grove so that the inner surfaces of the V-groove are bent together. When the polypropylene is heated appropriately, the two sides of the V-groove will, once joined, also weld together forming a weld joint 49 along the bead line 48. Like the hot gas welding method or the extrusion weld method used in joining two separate pieces of polypropylene material, heat bending the material by utilizing the groove and heat bar technique to join the polypropylene along the bend line creates a strong connection where the interior of the connection may exhibit evidence of a weld connection, but the exterior of the connection is seamless. Upon properly bending the material into the desired shape, such as a “U” shape, sides are welded to the top and the bottom may also be welded to the sides all as described above.

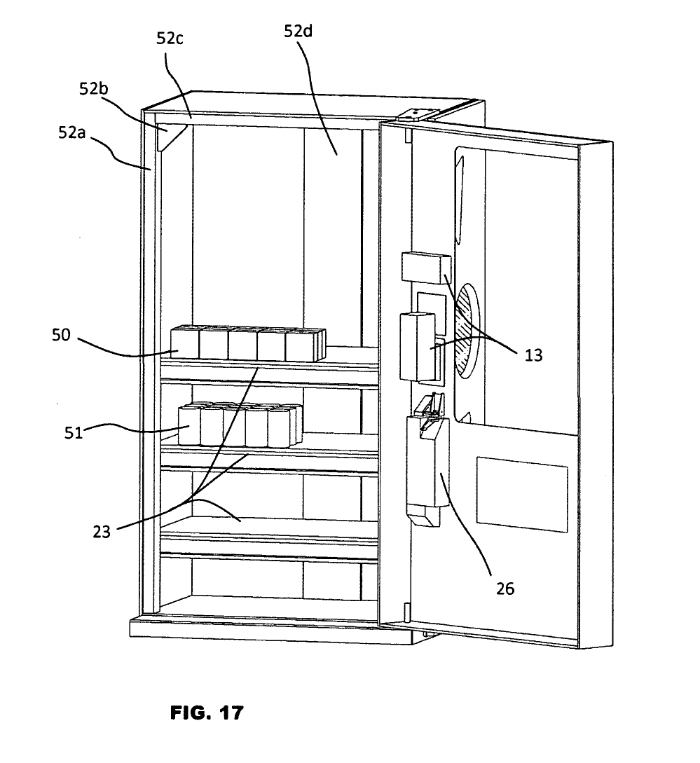

Once the basic shape of the enclosure has been achieved, the various components of the vending machine are added to the enclosure all as described above. Additionally, a front panel is added to complete the enclosure, and damaged sections are fixed also as described above. It should also be appreciated that, regardless of the method utilized to form the basic shape of the enclosure, additional polypropylene elements are capable of being efficiently added to the enclosure. For example, as shown in FIG. 17, shelving elements 23 in some embodiments are welded to the interior of the enclosure to hold various components of vending machine or to hold products 50, 51 to be vended. In certain embodiments, structural supports 52a, 52b, 52c, 52d are welded to the enclosure to add additional rigidity to the enclosure or to support other components of the vending machine. Utilizing a polypropylene material to form the additional elements allows for the elements to be welded directly to the enclosure and one another in order to provide a structure having minimal visual seams and without the need of additional fasteners.

Although the present invention has been described in terms of the preferred embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

What is claimed is:

1. An enclosure comprising:
a cabinet;
a door; and
a securing mechanism operatively engaged with said cabinet and said door to secure said door to said cabinet,
wherein said cabinet comprises a panel having a geometric shape and walls connected to and extending from said panel and forming a cavity bounded by said panel and said walls,
wherein said cabinet further includes a power supply, a controller, and at least one support structure for supporting a product, and wherein at least one fastener fastens one or more of said power supply, controller or support structure to said panel or to one of said walls,
wherein said panel and said walls are comprised of a homopolymer or a copolymer material.

2. The enclosure as in claim 1 wherein said homopolymer or said copolymer material is polypropylene.

3. The enclosure as in claim 2 wherein said door is comprised of a homopolymer or a copolymer material.

4. The enclosure as in claim 3 wherein said door further comprises:
a door panel having a geometric shape and door walls connected to and extending from said first door panel and forming a door cavity bounded by said door panel and said door walls; and
a transaction segment and a user interface wherein at least a portion of each of said transaction segment and said user interface are secured within said door cavity by one or more fasteners,
wherein at least one of said fasteners is secured to at least said first door panel or at least one of said door walls.

5. The enclosure as in claim 1 wherein said securing mechanism comprises at least two pins wherein said pins engage said cabinet and said door such that said door is capable of swiveling about an axis formed between said pins.

6. The enclosure as in claim 1 wherein said panel includes a panel interior surface and a panel exterior surface, opposite said panel interior surface, and at least one wall includes a wall interior surface and a wall exterior surface, opposite said wall interior surface,
wherein said cavity is bounded in part by said panel interior surface and said wall interior surface,
wherein said panel interior surface and said wall interior surface are connected along a joint, and
wherein no joint exists between said panel exterior surface and said wall exterior surface.

7. The enclosure as in claim 6 wherein said joint is comprised of fused homopolymer or copolymer material of the panel and the wall.

8. The enclosure as in claim 1 further comprising at least one support segment, said support segment comprising a homopolymer or a copolymer material compatible with the homopolymer or copolymer material of said panel or said walls such that said support segment is welded to at least one of said walls or said panel.

9. The enclosure as in claim 8 wherein said panel, said walls, said support structure for supporting a product and said support segment are each comprised of polypropylene and wherein said support structure for supporting a product is welded to at least one of said walls, said panel or said support segment.

10. An enclosure comprising:
a panel having a geometric shape and walls, connected to and extending from said panel forming a cavity bounded by said panel and said side walls;
wherein the panel includes a panel interior surface and a panel exterior surface, opposite said panel interior surface, and
one or more openings passing through said panel from said panel interior surface to said panel exterior surface,
wherein said panel and said walls are at least partially formed from a homopolymer or copolymer material.

11. The enclosure as in claim 10 further comprising:
a transaction segment and a user interface wherein at least a portion of each of said transaction segment and said user interface are secured within said cavity by one or more fasteners,
wherein at least one of said fasteners is secured to at least said panel or at least one of said side walls,
and wherein said enclosure forms a door of a product vending enclosure.

12. The enclosure as in claim 10 further comprising:
a piece of transparent material,
wherein said piece of transparent material covers at least one of said one or more openings to form a viewing window,
and wherein said enclosure forms a door of a product vending enclosure.

13. The enclosure as in claim 10 wherein the one or more openings includes a product dispensing hole, and wherein said enclosure forms a door of a product vending enclosure.

14. The enclosure as in claim 10 wherein said panel or said walls further include at least two pin holes, said pin holes forming an axis between them such that the panel and walls may rotate about said axis, and wherein said enclosure forms a door of a product vending enclosure.

15. The enclosure as in claim 10 wherein at least one wall includes a wall interior surface and a wall exterior surface, opposite said wall interior surface,
wherein said cavity is bounded in part by said panel interior surface and said wall interior surface,
wherein said panel interior surface and said wall interior surface are connected along a joint,
wherein no joint exists between said exterior surface and said wall exterior surface,
and wherein said enclosure forms a door of a product vending enclosure.

16. The enclosure as in claim 15 wherein said joint is comprised of fused homopolymer or copolymer material of the panel and the wall.

17. The enclosure as in claim 10 wherein said homopolymer or copolymer material is polypropylene, and wherein said enclosure forms a door of a product vending enclosure.

18. The enclosure as in claim 10 wherein the geometric shape of said panel is substantially rectangular, said panel further including:
a first side, a second side, opposite said first side, a top and a bottom, opposite said top;
a first side wall extending from said first side, a second side wall extending from said second side, a top wall extending from said top and a bottom wall extending from said bottom wherein said first wall is connected to said first side, said top wall and said bottom wall and wherein said second wall is connected to said second side, said top wall and said bottom wall; and
wherein a design is carved into at least one of said walls or said panel.

19. A method for manufacturing an enclosure comprising:
selecting a first sheet, a second sheet and a third sheet of homopolymer or copolymer material;
carving two substantially parallel groves in said first sheet to form three sections, a middle section bounded by said grooves and two side sections each bounded by an edge of said first sheet and a groove in said first sheet;
heating the grooves in said first sheet at least until the material within the grooves in said first sheet melts;
bending each of the two side sections of said first sheet along said grooves to form a U-shape;
welding said second sheet to an edge of said middle section of said first sheet and to an edge of each of said side sections of said first sheet;
welding said third sheet to an edge of said middle section of said first sheet and to an edge of each of said side sections of said first sheet thereby forming a cavity; and
connecting a transaction segment and a user interface within at least a portion of said cavity by fastening fasteners to one or more of said first sheet, said second sheet or said third sheet.

20. The method of claim 19, wherein said grooves are carved in a V-shape.

21. The method of claim 19, wherein said grooves are heated with a heated bending bar.

22. A method for manufacturing an enclosure, the method comprising:
selecting a first sheet, a second sheet and a third sheet of homopolymer or copolymer material;
carving two substantially parallel groves in said first sheet to form three sections, a middle section bounded by said grooves and two side sections each bounded by an edge of said first sheet and a groove in said first sheet;
heating the grooves in said first sheet at least until the material within the grooves in said first sheet melts;
bending each of the two side sections of said first sheet along said grooves to form a U-shape;
welding said second sheet to an edge of said middle section of said first sheet and to an edge of each of said side sections of said first sheet;
welding said third sheet to an edge of said middle section of said first sheet and to an edge of each of said side sections of said first sheet thereby forming a first cavity;
forming an opening through a thickness of said middle section of said first sheet panel; and
positioning a transparent material adjacent to said opening, so as to form a viewing window.

23. The method of claim 22, wherein said grooves are carved in a V-shaped groove.

24. The method of claim 22, wherein said grooves are heated with a heated bending bar.

25. The method of claim 22 further comprising attaching at least one securing mechanism to said enclosure and to a product vending machine so as to secure said enclosure to said product vending machine.
